(19) United States
(12) Patent Application Publication
(10) Pub. No.: US 2008/0224576 A1
(43) Pub. Date: Sep. 18, 2008

(54) Energy efficient generator

(76) Inventors: Charles Mass, Medicine Hat (CA); Riley Buttsman, Medicine Hat (CA); Rick Baker, Medicine Hat (CA); Andrea Baker, Medicine Hat (CA)

Correspondence Address: Jim Helfrich, 200 Choteau St., Sun River, MT, 59483, US

(21) Appl. No.: 11/724,694

(22) Filed: Mar. 16, 2007

(51) Int. Cl. H02K 19/26; H02K 11/00

(52) U.S. Cl. 310/68 R; 310/181

(57) ABSTRACT

A shell containing axles, magnets, electronics and diodes that provide for a more efficient generation of electricity. A tubular shell containing a spinning axle, fitted with magnets, magnetic bearings, computer to regulate and control generation functions provides power generation at a higher output to input power ratio than previously seen.

### RELATED APPLICATIONS

The present application is related to U.S. Pat. No. 6,954,019, issued Oct. 11, 2005, included by reference herein.

The present application is related to U.S. Pat. No. 6,271,614, issued Aug. 7, 2001, included by reference herein.

The present application is related to U.S. Pat. No. 6,262,508, issued Jul. 17, 2001, included by reference herein.

### FIELD OF THE INVENTION

The present invention relates to electrical generators and, more particularly, to an electrical generator that requires less input energy per unit of output energy.

### BACKGROUND OF THE INVENTION

Ever since the invention of energy generating machines the goal has been to increase efficiency. Many generators use other forms of energy and through the conversion processes use more energy than they produce. This has created a problem in a world where energy sources are becoming limited, especially fossil fuels, which also create pollution and other hazards to the environment and health. Therefore there is a strong need for generators that use less energy per unit of output and use energy sources that are less harmful to the environment.

Other prior art solutions have been developed around FREE energy such as solar, wind and hydro. These prior art systems do provide added benefits from non use of fossil fuels and since there is no cost of the raw energy used, do provide a solution to pollution caused by fossil fuels or to the high cost of fossil fuels and nuclear energy. These prior art solutions do provide some relief to dependence on foreign energy and have taken a good foot hold in the US. These prior art solutions are and have been more popular in many foreign countries where low cost reliable energy has been an issue longer than it has In North America.

These prior art solutions have also produced other problems such as increasing water temperature or reducing water flows in rivers where hydro power is used and a reversal of hydro power use is in progress in many areas due to residents of those communities realizing that the disadvantages outweigh the advantages in many instances, especially when irrigation and fisheries are considered. Wind generation is some what limited because wind is only available in unreliable quantities in only limited areas making dependence upon wind generation suspect. In addition, wind generation has met with some resistance because of its “view restricting” characteristics, so it is not welcome in all areas. Wind generation has depended upon very large scale and expensive wind farms to show any practical payback at this time.

Solar generation is limited to generation during the day time and thus becomes very limited and quite expensive for more Northern areas where energy consumption increases during the winter, where longer nights and shorter day light periods exist at that time of year. It is quite land hungry, thus increasing its cost per KW substantially.

It is therefore an object of the invention to provide for lower energy input relative to energy output.

It is another object of the invention to reduce energy production cost.

It is another object of the invention to provide environmental advantages through the lower consumption of fossil fuels.

It is another object of the invention to provide lower cost energy.

It is another object of the invention to provide practical, lower cost power to remote locations where power is not practical.

### SUMMARY OF THE INVENTION

In accordance with the present invention, there is provided a shell containing axles, magnets, electronics and diodes that provide for a more efficient generation of electricity. A tubular shell containing a spinning axle, fitted with magnets, magnetic bearings, computer to regulate and control generation functions provides power generation at a higher output to input power ratio than previously seen.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a side cut away view of an internal view of the present invention showing the working parts of the unit;

FIG. 2 is a side perspective view of a generator in relation to how the unit sits in its stand and relation to ground and wiring location;

FIG. 3 is a schematic side elevational view of an energy efficient generator external shell;

FIG. 4 is a schematic side elevational view of an energy efficient generator external shell situated in its stand;

FIG. 5 is a side sectional view of a close up of the magnetic drive depicting the layout of the electromagnets;

FIG. 6 is an enlarged side sectional view of a close up of the magnetic drive depicting the layout of the electromagnets;

FIG. 7 is a side elevation view of a magnetic drive unit; and

FIG. 8 is a schematic view of a magnetic axle stationary unit.

For purposes of clarity and brevity, like elements and components will bear the same designations and numbering throughout the Figures.

### DESCRIPTION OF THE PREFERRED EMBODIMENT

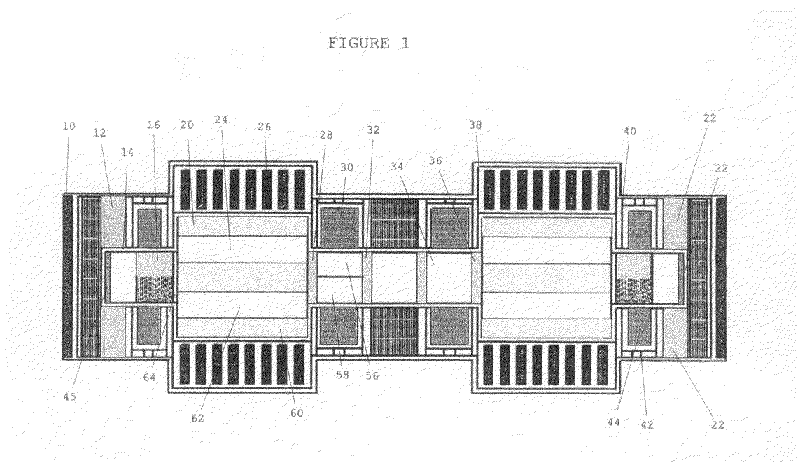

FIG. 1 is a side cut away view of an internal view of the present invention showing the working parts of the unit.

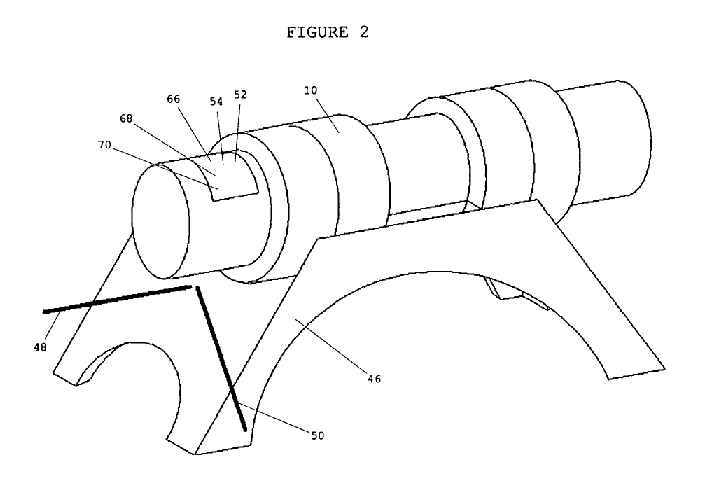

FIG. 2 is a side perspective view of a generator in relation to how the unit sits in its stand and relation to ground and wiring location.

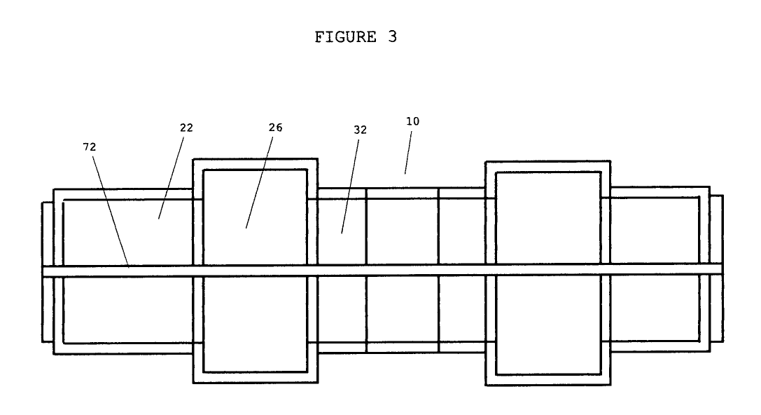

FIG. 3 is a schematic side elevational view of an energy efficient generator external shell 10.

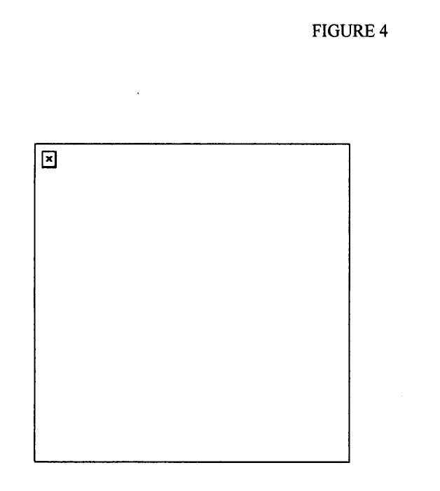

FIG. 4 is a schematic side elevational view of an energy efficient generator external shell 10 situated in its stand.

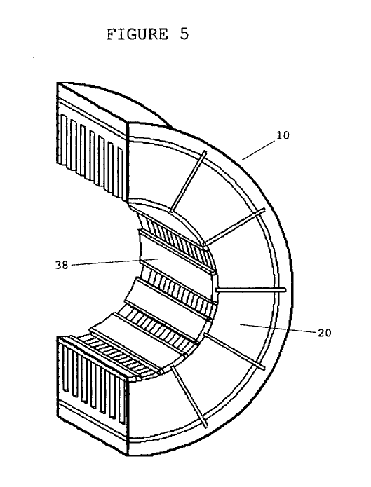

FIG. 5 is a side sectional view of a close up of the magnetic drive depicting the layout of the electromagnets.

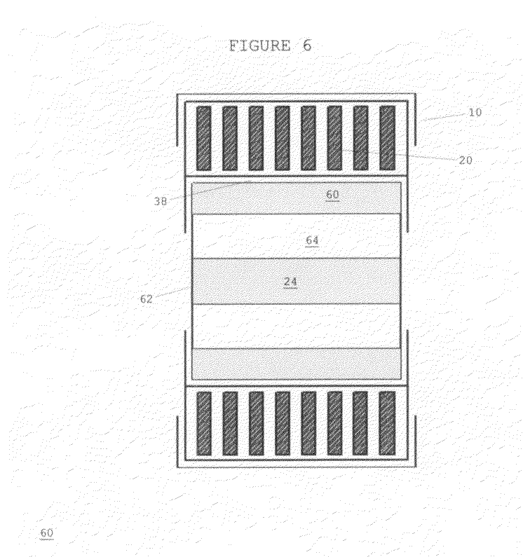

FIG. 6 is an enlarged side sectional view of a close up of the magnetic drive depicting the layout of the electromagnets.

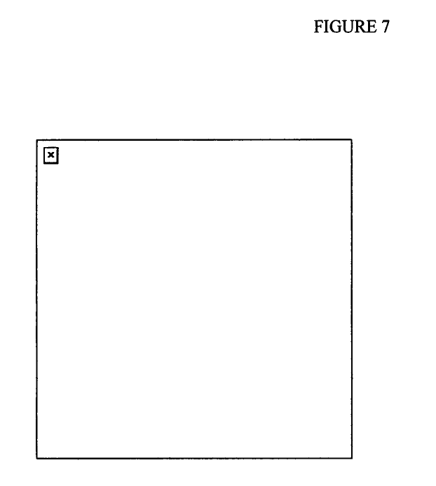

FIG. 7 is a side elevation view of a magnetic drive unit 26.

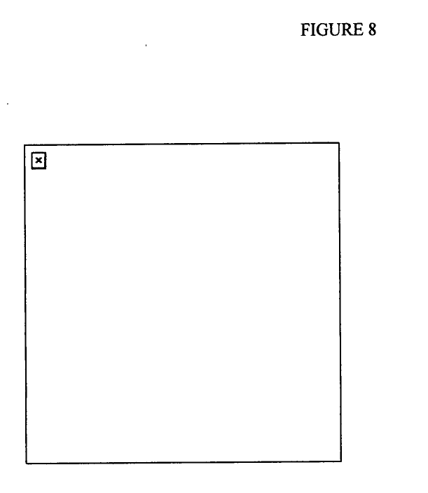

FIG. 8 is a schematic view of a magnetic axle stationary unit 74.

Referring now to FIG. 1.; In a preferred embodiment of the present invention illustrated is a configuration of the nine main substructures and multiple sub-sub structures of the engine including the external shell 10 generally cylindrical in nature containing the magnetic drive unit 26, electrical generation unit 32, energy distribution chip 52 not shown, with it's energy transfer structure, generally indicated magnetic axle stabilization unit 22, energy distribution chip 52 not shown, magnetic field dampener 36, electrical generation unit 32 magnetic field dampener 36, magnetic drive unit 26 magnetic field dampener 36, positive node 50 and negative node 48.

1) The external shell 10 is generally cylindrical composed of high density carbon fiber magnetically retardant composed of compartmentalized forms to secure the nine substructures of the engine.

2) The magnetic drive unit 26 consists of: A magnetic drive axle 24 composed of a magnetic axle 14 with two north polarities generally opposing each other and made up of two substructures containing six sets of three magnets each, magnet a 60, magnet b 62 and magnet c 64, balanced to prevent compromising the axle 14 stability while allowing a harmonized, balanced flow of opposing magnetic fields. This set of then six magnets becomes the responsive force in the engine. A stationary magnetic drive 20 housed directly against the external shell 10 composed of twelve magnets cut and angled to oppose the magnets in the axle 14, the magnetic polarity of each of the magnets is angled to cause a constant push or magnetic fall that does not cease making the stationary magnetic drive 20 the directive force. The opposing relation of the stationary magnetic drive 20, which is the directive force and the magnetic drive axle 24, which is the responsive force, creates a centrifugal or gyroscopic force, thus causing the axle 14 to rotate in the responsive direction converting the natural inherent magnetic forces into inertial energy. The stationary magnetic drive 20 unit can and does become an intensified directive force and a recessive directive force when electrical energy is applied in a positive direct current and also a negative direct current.

3) Electrical generation unit 32 is made up of two substructures, the stabilized generation unit 30 directly housed against the external shell 10 and composed of a magneto 42; four magnets known as the axle segment magnet 16, comprised of magnet aa 56 and magnet bb 58, composed of Neodymium Iron Boron arranged north to north, south to south in a generally circular structure, wound in copper wire creating an electrical charge when acted upon by another magnetic force, and a magneto housing 40 to ensure no cross contamination of polarities. The electrical generation unit core 34 is made up of two magnets arranged north to north, south to south, forming a cylinder. The electrical generation unit core 34, is directly connected to the magnetic drive axle 24 possessing the electrical generation unit core 34 with centrifugal inertial energy caused by the stationary magnetic drive 20 converting magnetic energy to centrifugal energy. While spinning, the electrical generation unit core 34 becomes the magnetic link to the mini turbine that is the electrical generation unit 32 sending electrical energy via high conduction wire to the energy distribution chip.

4) The energy distribution chip, not shown, is part of the energy transference system, composed of two parts: the energy distribution chip 52 not shown, and the energy transference structure. The energy transference structure, is the wiring structure post energy distribution chip 52 position. The energy distribution chip 52 not shown, is composed of silicon constructed to function in a magnetic field while distributing the electrical energy generated by the electrical generation unit 32 and the electrical energy flows out and into from the positive node 50, and negative node 48, at either end of the unit while a variance of positive/negative current is sent/removed to/from the stationary magnetic drive 20 unit. The chip responds to the demand of electrical energy at the positive node 50, and negative node 48, and the supply is produced.

The power draw at “rest” balances itself out. As the centrifugal motion of the main drive axle 14 builds in intensity from the constant input of magnetic energy, the electrical generation unit core 34 increases rotational velocity, thus a greater production of electricity occurs. The electricity then flows into the energy distribution chip 52. The energy distribution chip 52 then responds to an outward flow or demand of electrical energy by the build up or stagnation of electrons. When the unit is at “rest”, there is no flow of electrons; no demand for energy, therefore electrical energy is transferred through a new route, to the stationary magnetic drive 20. This cycle continues until a balance between the magnetic energy inputs exists and is then transferred to the centrifugal energy. This transference then goes to the axle 14 to the electrical generation unit 32 to create a balance of electrical energy production. This transfers to electromagnetism in the magnetic drive unit 26. The natural magnetic exertion of the stationary magnetic drive 20 is therefore met.

When the unit requires electricity, the energy distribution chip 52 recognizes the flow of electrons and closes the pathway to the magnetic drive unit 26 and allows free flow to/from the positive node 50, and negative node 48 of the unit. Energy that was involved in the balance of electrical energy production to the opposing electromagnetic in the magnetic drive unit 26 against the natural magnetic exertion of the stationary magnetic drive 20 now unbalances from the decrease of electromagnetic opposition. The stationary magnetic drive 20 has full magnetic exertion on the magnetic drive axle 24 allowing an increase of centrifugal velocity. Thus, the energy that was balancing the system is now decreased, allowing more force, more energy production, creating greater electricity that is flowing to the positive node 50 and the negative node 48, then to the “consumer”. In the case of a greater demand of electricity, the path to the magnetic drive unit 26 is reopened, only in reversed polarities allowing for energy to flow and create a “boost” of similarly charged electromagnetic energy, increasing the natural magnetic exertion of the stationary magnetic drive 20.

This process continues until the demand of energy is met, then balances out only at a greater intensity. A build up of energy will continue to increase until a surplus of electrons are created or an inhibitor is in place, then a balance will ensue. This structure follows suit of the basic supply and demand ideals.

The electromagnetism described above is designed within the individual magnets of the stationary magnetic drive 20. Each individual magnet has ports and canals as part of the structure of the magnet. Copper wiring 38 wraps around within the canal and port then transfers to the next magnet by small electricity transfer nodes.

5) The magnetic axle stabilization unit 22, generally indicated works as a whole to stabilize both the vertical and horizontal axis ensuring that the axle 14 stays in its proper place and eliminates any wobble that would be created by the electrical generation unit 32. There are two of a magnetic drive axle 24 at either end on the main drive axle 14. Each generally indicated magnetic axle stabilization unit 22, has two sets of two magnets. One in the horizontal stabilizing magnet 18, which is a disc with a pole on either side of the faces, south on one side, north on the other. The horizontal stabilizing magnet 18 ensures the axle 14 remains in place, not pushing to one side or the other so that all parts of the axle 14 do not rub against any part of the stationary system causing friction and damage. The second magnet set, the vertical magnetic axle stabilization unit 44 generally indicated, is a single cylinder with the south polarity in the center from face to face of the cylinder with the north polarity on the outer circumference of the cylinder. The vertical magnetic axle stabilization unit 44 generally indicated, balances the axle 14 to ensure a wobble is not created by the electrical generation unit 32. The horizontal axis stabilizing magnets 45 is a series of 2 magnets help keep the axle 14 in place in a frictionless rotation along the given axis.

The stationary magnetic axle stabilization unit 12 is the opposing magnetic force to the magnetic axle 14 stabilization unit on the axle 14 The horizontal stabilizing magnet 18 is a disc with opposing poles to the horizontal stabilizing magnet 18. The only difference in this case is that this magnet is a ring with the northern pole facing inward, while the southern pole is on the outer circumference. Without the generally indicated magnetic axle stabilization unit 22, the axle 14 would fail due to the friction and damage and render the unit nonfunctional.

6) The energy distribution chip/magnetic drive axle 24 magnetic field dampener 36 not shown is a thin, yet very dense disc of highly compressed carbon fiber that retards the transfer if magnetic energy from the magnetic drive axle 24 to the energy distribution chip 52 not shown.

7) The electrical generation unit 32/magnetic drive axle 24 magnetic field dampener 36 is a thin, yet very dense disc of highly compressed carbon fiber that retards the transfer if magnetic energy from the magnetic drive axle 24 to the energy distribution chip 52 not shown.

8) The electrical generation unit/magnetic drive unit magnetic field dampener 28 is a thin, yet very dense disc of highly compressed carbon fiber that retards the intermingling of the magnetic field of the electrical generation unit 32 and of the magnetic field of the magnetic drive unit 26.

Each of the magnetic field dampeners, with the exception of the energy distribution chip 52/magnetic drive axle 24 dampener, have two parts, a stationary and an axle 14 placement. This is to ensure that there is no assisted magnetic degradation.

9) The output positive node 50/negative node 48 allow the electrical energy to be transferred to the consumer apparatus.

Each magnet is composed of Neodymium Iron Boron or NdzFe14B, often abbreviated as NdFeB. NdFeB is the most recent commercial addition to the family of modem magnetic materials. At standard temperatures NdFeB magnets exhibit the highest properties of all magnets. Thus the present invention will have a vacuum interior to ensure minimal heat due to air friction. In extreme temperatures magnetic degradation is at a minimal and the efficiency if the engine is minutely compromised. The B-H curve, or demagnetization curve, describes the conditions under which magnets are used in practice. The three most important characteristics of the B-H curve are the points at which it intersects the B and H axis, at Br, which is the residual induction; and at Hc, which is the coercive force; and at a maximum flux, Bhmax, which is the maximum energy product. The higher the product, the smaller the size of magnet is needed. NdFeB has a Br or maximum flux of 12,800 Br. This is the highest rate of commercial magnet use. In actual useful operation, permanent magnets can only reach a point close to this rate. NdFeB has a Hc of 12,300 Hc, yet again, the highest commercial use rating. This represents the strength of a magnet before it becomes demagnetized by an intensified outside magnetic force. NdFeB had a Bhmax of 40, which is the highest rate for commercially used magnets. This means that a small NdFeB magnet is capable for a very large and strong magnetic field.

Referring again to FIG. 1, in operation, the energy “harnessing” any “generating” of the present invention, in actuality, is transferring energy in physical design. The natural physical attraction and repulsion of polarities of magnets are manipulated by architectural design to create a “magnetic fall”. A magnetic fall is an occurrence of magnetic energy transferred into inertial energy within a cylindrical construction. The repulsions of the north polarities of magnets, properly aligned, create a rotational direction of the whole internal structure. The present invention harnesses its energy at the magnetic drive.

This unit is composed of two subunit magnetic clusters, arranged and angled to magnetically oppose the other subunit within the given structure. From magnetic repulsion to inertial motion.

The inertial energy that was harnessed is then transferred structurally to the rest of the axle 14. From magnetic repulsion to inertial motion which is transferred throughout the structure of the axle 14. The inertial energy is transferred to a pseudo/mini turbine electrical generation unit core 34. Inertial energy, motion generated by magnetic drive, then transferred and inertial energy is given to generate electrical energy via the mini turbine generator 54 not shown. The electrical generation unit 32 has its own subunit located on the axle 14 directly beside the magnetic drive. Using a magnets' natural attraction and repulsion, the electrical generation unit 32 converts inertial energy into electrical discharge or electricity. This electrical charge is directed to the energy distribution chip 52.

The magnetic repulsion that is orchestrated continually feeds more energy to be converted into ever increasing inertial velocity. This is then transferred to the electrical generation unit 32, thus creating more electricity. The “overflow” of electrons that the energy distribution chip 52 receives is sent back to the magnetic drive unit 26. The magnetic drive unit 26 then generates a responding magnetic attraction. This creates a reduction to the whole of the initial magnetic opposition.

Stabilization of the ever increasing velocity of the magnetic drive is accomplished by implementing a weaker attraction force of polarity to limit the magnetic repulsion that gets converted into inertial energy. This is accomplished by implementing an electromagnet in the structure of the stationary application of magnetic force. The stationary subunit of the magnetic drive is composed of twelve individual magnets or “Indy Mags”. The key to the “energy balancing act” is located in the magnetic drive unit 26. A single Indy Mag projects the chosen polarity repulsion with the like polarity on the axle 14 subunit of the magnetic drive. This, in turn, leads to electrical conversion which is introduced into the Indy Mag and flows through copper wrapped around the internal structure. It then is transferred to the next Indy Mag via ports.

The Indy Mag is designed for balance. On its own, it magnetically projects a chosen polarity. And with the integration of an electromagnetic it has the ability to respond in variation of electromagnetism to reduce or increase the magnetic projection of the chosen polarity. Thus, an Indy Mag working with the whole subunit allows a certain directive force that the axle 14 responds to. When an electrical charge is introduced, the electromagnets generate a certain recessive force that act on the magnetic drive axle 24 subunit to reduce the magnetic drive axle 24 response to the magnetic directive force. This action creates an electromagnet designed to oppose the chosen polarity for repulsion. The more repulsive magnetic energy an Indy Mag projects, the greater the inertial velocity the axle 14 gains and the greater the electrical generation. The greater the electrical generation, the greater the strength of the electromagnet in the Indy Mag. This, in turn, creates a stronger electromagnet field to oppose the set polarity for repulsion. Thus a balance will be achieved.

The repulsive flow of directed magnetic repulsion equals controlled direction and increasing inertial energy generated. Without the integration if the electromagnet in the Indy Mag, the axle 14 would continue to convert magnetic energy to inertial energy, gaining velocity until gyroscopic energy would tear the axle 14 apart. With the proper application of electromagnetism in this unit the continually increasing magnetic to inertial energy is harbored and a variable balance is met.

Segment C = 82524.54223 ÷ 2 = 41262.27112

| | | | |
|---|---|---|---|
| SMASU | | | |
| Magnetic Field Density | MFD | MFD | MFD |
| 1253.929466 | −1028.101051 | 2997.506651 | 10150.02691 |
| SEGU | | CEGU | |
| MFD | | MFD | |
| −702.6727113 | | 1928.480038 | |
| SMD | | MDA | |
| MFD | | MFD Segment A | |
| 64970.5171 | | −65100.9648 | |
| MDA | | MDA | |
| MFD Segment B | | MFD Segment C | |
| 615416.2353 | | 41262.27112 | |
| MASU | | | |
| | 10150.02691 | | 2992.50665 |
| | +(−)1028.101051 | | +1253.929466 |
| | 9121.925859 | | 4246.436116 |
| EGU | | | |
| | −702.6727113 × 2 = 1405.345423 | | |
| | 1928.480038 × 2 = 3856.960076 | | |
| | 2451.614653 | | |
| SMD | | | |
| | 615416.2353 | | 64970.5171 |
| | +(−)65100.9648 | | +41262.27112 |
| | X = 550315.2705 | | Y = 106232.7882 |
| | 64970.5171 | | |
| | +550315.2705 | | |
| | Z = 615285.7876 | | |

### Formulation

### Magnetic Drive

a=Internal Drive Stabilizing Magnet (MDA)
b=Indy Magnet Stationary Force (SMD)
c=space between structural magnets

$$Represented as A$$

$$\begin{matrix}a + b - c ( incorporated ) = total magnetic repulsion to structures \\ = primary stabilization of MDA . \\ = secondary magnetic flux drive .\end{matrix}$$

d=Internal Main Drive Magnet (MDA)
b=Indy Magnet Stationary Force (SMD)
c=space between structural magnets

$$Represented as B$$

$$\begin{matrix}d + b - c = total magnetic repulsion to structures \\ = secondary stabilization of MDA \\ = primary drive ( hard flux )\end{matrix}$$

AB=directive responsive force
M=mass
g=gyroscopic force
v=velocity
I=inertial energy
AB is relative, a constant.

AB applied to structure has constant increase of “v” on M. “v” times M equals “I”.

AB(vM=I) in motion.

Thus energy is transferred, magnetic to inertial.

### Formulation

### Electrical Generation

I=Inertial energy (generated by MD)
v=velocity
S1=surface area/size (MD) (axle 14)
S2=surface area/size (EGU) (axle 14)
sd=size/surface area difference

S1−S2=sd
S1(I)S2(I) Thus greater rate of rotation of S2.
External area of S2=>v thus >Intensity of magnetic field or Gauss (G).
   N1=Northern polarity stationary magnet 1
   N2=Northern polarity stationary magnet 2
   n1=Northern polarity axle 14 magnet 1
   n2=Northern polarity axle 14 magnet 2
   C=space between structural magnets

n1+n2(N1+N2)=n1+n2(N1+N2)=C(C)Approaching resistance C(C)Enhanced recessive Push

Balance of structure

N1+S2=n1+S2
N2+N1S2+S1 Thus build up of energy on approach, excess energy polarized negative and transferred due to electro coil and magnetization+motion.
   All represented as T
   E=electrical energy generated
   T=magnetic to electrical energy transferred
   tI=transferred inertial energy
   I=inertial energy
   mf=inertial magnetic force (MD)

### E=T(tI)mf

Mf(I)

### Variable Balance

E=electrical energy
r=wire resistance
em=innate electromagnet (Indymag) (SMD)
EM+=enforcing electromagnet (Indymag) (SMD)
EM−=opposing electromagnet (Indymag)(SMD)
mf=inertial magnet force (MD)
E−r+em=EM+ or EM−
Flow E directive−r+em=EM+
Flow E recessive−r+em=EM
EM++mf>mf thus, greater inertial energy
   Imbalance greater inertial energy=greater electrical generation
EM−+mf=<mf thus, less inertial energy
   Balance less inertial energy=less than or equal to inertial energy

### Variable Imbalance

(release of electrical energy)

If E−r is redirected to external energy transfer parts then EM+ or EM− becomes “em”, thus “MF” returns to original state and is unbalanced, building v, g, I and ultimately, ever increasing electrical generation.

When external energy requirements are met, excess electrical energy is transferred back into the cycle to create EM−+mf=<mf only at a greater velocity of motion, so that the energy requirements of the external apparatus and energy requirement of the internal cycle at balance are met.

Referring now to FIG. 2, in a preferred embodiment of the present invention a generator stand 46 is formed to serve as a holding unit for the generating unit. An external shell 10 contains all of the components mentioned in FIG. 1 in a sealed controlled environment to protect the internal components from contamination and atmospheric air. The energy distribution chip 52, is located in the external shell 10 in a compartment that also contains the lcd screen 66 that allows the operator to visually perceive unit functions, the interactive pad 68 that permits the operator to input desired functions and menu selections and the computer processor unit housing 70 that serves to protect the internal components from shock, physical damage, and magnetic and electromagnetic fields. Positive node 50 and negative node 48 are shown for connecting the present invention to device that will consume its energy output.

Referring now to FIG. 3, in a preferred embodiment of the present invention a generator external shell 10 contains all of the components mentioned in FIG. 1 in a sealed controlled environment to protect the internal components from contamination and atmospheric air. The location of the magnetic axle stabilization unit 22 is generally indicated as well as the magnetic drive unit 26. The general location of the electrical generation unit 32 is also depicted as is the axle support rod 72 which strengthens the core of the axle 14 as a whole acting to maintain its rigidness' though the unit.

Referring now to FIG. 4, in a preferred embodiment of the present invention a generator external shell 10 situated in its stand containing all of the components mentioned in FIG. 1 in a sealed controlled environment to protect the internal components from contamination and atmospheric air. Within the external shell 10 is a compartment that contains the lcd screen 66 that allows the operator to visually perceive unit functions, the interactive pad 68 that permits the operator to input desired functions and menu selections and the computer processor unit housing 70 that serves to protect the internal components from shock, physical damage, and magnetic and electromagnetic fields. The location of the magnetic drive unit 26 is generally indicated. The general location of the electrical generation unit 32 is also depicted. The external shell 10 is shown seated into the generator stand 46 and both negative node 48 and positive node 50 are indicated along with the general location of the energy distribution chip 52.

Referring now to FIG. 5, in a preferred embodiment of the present invention a close up of the magnetic drive depicting the layout of the electromagnets is shown. The external shell 10 contains the stationary magnetic drive 20 and the copper wiring 38.

Referring now to FIG. 6, in a preferred embodiment of the present invention a close up of the magnetic drive unit 26 depicting the layout of the electromagnets is shown. The external shell 10 contains the stationary magnetic drive 20, the copper wiring 38 and the magnetic drive axle 24.

Referring now to FIG. 7, in a preferred embodiment of the present invention shown is a side view of the magnetic drive unit 26 depicting the layout of the electromagnets. The stationary magnetic drive 20, copper wiring 38 and the magnetic drive axle 24 are depicted in relation to the electrical generation unit 32/magnetic drive unit 26

Referring now to FIG. 8, the magnetic axle stationary unit 74 consists of the magnetic field dampener 36, vertical magnetic axle stabilization unit 44, and the horizontal axis stabilizing magnets 45.

Although the description provided above contains many specificity's, these should not be construed as to limit the scope of the present invention but rather as illustrations of some of the presently preferred embodiments of this present invention. Various other embodiments and ramifications are possible within the scope of the present invention. For example, other arrangements of the various components and contact means are possible as well as required in configurations of various output capacities. Therefore, the scope of the present invention should be considered rather than the specific examples provided.

Referring now to FIG. 8: in a preferred embodiment of the present invention, the magnetic axle stationary unit 74 is comprised of the vertical magnetic axle stabilization unit upper 78 serving as an axle 14 and the vertical magnetic axle stabilization unit lower 76, portion serving as the stationary component. The horizontal axis stabilizing magnets upper 80 unit pushes or repels against the horizontal axis stabilizing magnets lower 82 unit, and each end of the axle 14 is fitted with a unit to facilitate the totally stabilization and rotation of the axle 14, creating a stabilized rotation along the length of the axle 14.

The vertical magnetic axle stabilization unit upper 78, pushes or repels against vertical magnetic axle stabilization unit lower 76, to minimize or completely stop any “wobble” that may have been created by other components of the axle 14. The magnetic field dampener 36 serves to lesson the magnetic effect on other components of the present invention. The upper or top component 84 inserts into the bottom of the lower or bottom component 86 and creating a magnetic repulsion between the horizontal axis stabilizing magnets upper 80 and the horizontal axis stabilizing magnets lower 82 to work as unit horizontal axis stabilizing magnets 45 through forced repulsion by means of magnetic forces focused on the sides resulting in a stabilization of the x and z axis′.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An energy efficient generator for reducing energy input for electrical generation output, comprising: means for opposing the magnetic force to the magnetic drive axle;
means for supporting and centering of energy efficient generator internal components;
means for interacting with the stationary segment of the electrical generation unit to induce electrical generation;
means for ensuring the axle remains in place by preventing it from being pushed to one side or the other;
means for controlling magnetic polarity of each of the magnets which are angled to cause a constant push or magnetic fall that does not cease;
means for ensuring that the axle stays in its proper place and eliminates any wobble that would be created by the electrical generation unit;
means for serves to secure the twelve magnets used to oppose the magnets of the stationary magnetic drive;
means for creating a centrifugal or gyroscopic force from responsive and directive forces contained in the magnets to cause the drive axle to rotate in the responsive direction converting the forth dimensional magnetic energy into inertial energy;
means for retarding the intermingling of the magnetic field of the electrical generation unit with the magnetic field of the magnetic drive unit;
means for retarding the transfer of magnetic energy to/from the electrical generation unit from/to the magnetic axle stabilization unit;
means for conducting the flow of electrons generated by the interaction of magnetic fields;
means for insulating the magneto from any other electro magnet or magnetic field, rigidly connected to said means for conducting the flow of electrons generated by the interaction of magnetic fields;
means for to create an electrical charge when acted upon by another magnetic force;
means for keeping the axle in place in a frictionless rotation along the given axis;
means for functioning in a magnetic field while distributing the electrical energy generated by the electrical generation unit. the chip responds to the demand of electrical energy at the positive and negative nodes and the supply is produced;
means for working with magnet bb to create a magnetic flux pulse as in a standard electrical generator. magnet aa and magnet bb are part of the electrical generation unit;
means for working with magnet aa in the electrical generation unit to create a magnetic flux pulse as in a standard electrical generator;
means for assisting in the stabilization of the magnetic drive axle;
means for the main response of the conversion, opposition of the magnetic repulsion;
means for assisting in the extenuating the flux of magnet b.

2. The energy efficient generator in accordance with claim 1, wherein said means for opposing the magnetic force to the magnetic drive axle comprises a magnetic stationary magnetic axle stabilization unit.

3. The energy efficient generator in accordance with claim 1, wherein said means for supporting and centering of energy efficient generator internal components comprises a cylindrical shaft axle.

4. The energy efficient generator in accordance with claim 1, wherein said means for interacting with the stationary segment of the electrical generation unit to induce electrical generation comprises a magnets constructed to be like that of a turbine generators axle segment axle segment magnet.

5. The energy efficient generator in accordance with claim 1, wherein said means for ensuring the axle remains in place by preventing it from being pushed to one side or the other comprises a magnetic, disc shaped horizontal stabilizing magnet.

6. The energy efficient generator in accordance with claim 1, wherein said means for controlling magnetic polarity of each of the magnets which are angled to cause a constant push or magnetic fall that does not cease comprises a configuration composed of twelve magnets that are cut and angled to oppose the magnets in the magnetic drive axle stationary magnetic drive.

7. The energy efficient generator in accordance with claim 1, wherein said means for ensuring that the axle stays in its proper place and eliminates any wobble that would be created by the electrical generation unit comprises a magnetic axle stabilization unit.

8. The energy efficient generator in accordance with claim 1, wherein said means for serves to secure the twelve magnets used to oppose the magnets of the stationary magnetic drive comprises a magnetic, rigid, generally conical magnetic drive axle.

9. The energy efficient generator in accordance with claim 1, wherein said means for creating a centrifugal or gyroscopic force from responsive and directive forces contained in the magnets to cause the drive axle to rotate in the responsive direction converting the forth dimensional magnetic energy into inertial energy comprises a composed of a magnetic axle, composed of a stationary magnetic drive magnetic drive unit.

10. The energy efficient generator in accordance with claim 1, wherein said means for retarding the intermingling of the magnetic field of the electrical generation unit with the magnetic field of the magnetic drive unit comprises a thin, highly compressed fiber carbon, disc shaped electrical generation unit/magnetic drive unit magnetic field dampener.

11. The energy efficient generator in accordance with claim 1, wherein said means for retarding the transfer of magnetic energy to/from the electrical generation unit from/to the magnetic axle stabilization unit comprises a thin dense disk of highly compressed carbon fiber magnetic field dampener.

12. The energy efficient generator in accordance with claim 1, wherein said means for conducting the flow of electrons generated by the interaction of magnetic fields comprises a copper wiring wound around magnet of the magneto copper wiring.

13. The energy efficient generator in accordance with claim 1, wherein said means for insulating the magneto from any other electro magnet or magnetic field comprises a highly compressed carbon fiber surrounding the wound copper magneto housing.

14. The energy efficient generator in accordance with claim 1, wherein said means for to create an electrical charge when acted upon by another magnetic force comprises a four magnets arranged north to north and south to south magneto.

15. The energy efficient generator in accordance with claim 1, wherein said means for keeping the axle in place in a frictionless rotation along the given axis comprises a magnetic horizontal axis stabilizing magnets.

16. The energy efficient generator in accordance with claim 1, wherein said means for functioning in a magnetic field while distributing the electrical energy generated by the electrical generation unit. The chip responds to the demand of electrical energy at the positive and negative nodes and the supply is produced comprises a silicon energy distribution chip.

17. The energy efficient generator in accordance with claim 1, wherein said means for working with magnet bb to create a magnetic flux pulse as in a standard electrical generator. Magnet aa and magnet bb are part of the electrical generation unit comprises a magnetic magnet aa.

18. The energy efficient generator in accordance with claim 1, wherein said means for working with magnet aa in the electrical generation unit to create a magnetic flux pulse as in a standard electrical generator comprises a magnetic magnet bb.

19. The energy efficient generator in accordance with claim 1, wherein said means for assisting in the stabilization of the magnetic drive axle comprises a magnetic magnet al.

20. The energy efficient generator in accordance with claim 1, wherein said means for the main response of the conversion, opposition of the magnetic repulsion comprises a magnetic magnet b.

21. The energy efficient generator in accordance with claim 1, wherein said means for assisting in the extenuating the flux of magnet b comprises a magnetic magnet c.

22. The energy efficient generator in accordance with claim 1, wherein said means for <purpose> comprises an axle support rod.

23. An energy efficient generator for reducing energy input for electrical generation output, comprising: a magnetic stationary magnetic axle stabilization unit, for opposing the magnetic force to the magnetic drive axle;
a cylindrical shaft axle, for supporting and centering of energy efficient generator internal components;
a magnets constructed to be like that of a turbine generators axle segment axle segment magnet, for interacting with the stationary segment of the electrical generation unit to induce electrical generation;
a magnetic, disc shaped horizontal stabilizing magnet, for ensuring the axle remains in place by preventing it from being pushed to one side or the other;
a configuration composed of twelve magnets that are cut and angled to oppose the magnets in the magnetic drive axle stationary magnetic drive, for controlling magnetic polarity of each of the magnets which are angled to cause a constant push or magnetic fall that does not cease;
a magnetic axle stabilization unit, for ensuring that the axle stays in its proper place and eliminates any wobble that would be created by the electrical generation unit;
a magnetic, rigid, generally conical magnetic drive axle, for serves to secure the twelve magnets used to oppose the magnets of the stationary magnetic drive;
a composed of a magnetic axle, composed of a stationary magnetic drive magnetic drive unit, for creating a centrifugal or gyroscopic force from responsive and directive forces contained in the magnets to cause the drive axle to rotate in the responsive direction converting the forth dimensional magnetic energy into inertial energy;
a thin, highly compressed fiber carbon, disc shaped electrical generation unit/magnetic drive unit magnetic field dampener, for retarding the intermingling of the magnetic field of the electrical generation unit with the magnetic field of the magnetic drive unit;
a thin dense disk of highly compressed carbon fiber magnetic field dampener, for retarding the transfer of magnetic energy to/from the electrical generation unit from/to the magnetic axle stabilization unit;
a copper wiring wound around magnet of the magneto copper wiring, for conducting the flow of electrons generated by the interaction of magnetic fields;
a highly compressed carbon fiber surrounding the wound copper magneto housing, for insulating the magneto from any other electro magnet or magnetic field, rigidly connected to said copper wiring;
a four magnets arranged north to north and south to south magneto, for to create an electrical charge when acted upon by another magnetic force;
a magnetic horizontal axis stabilizing magnets, for keeping the axle in place in a frictionless rotation along the given axis;
a silicon energy distribution chip, for functioning in a magnetic field while distributing the electrical energy generated by the electrical generation unit. The chip responds to the demand of electrical energy at the positive and negative nodes and the supply is produced;
a magnetic magnet aa, for working with magnet bb to create a magnetic flux pulse as in a standard electrical generator. Magnet aa and magnet bb are part of the electrical generation unit;
a magnetic magnet bb, for working with magnet aa in the electrical generation unit to create a magnetic flux pulse as in a standard electrical generator;
a magnetic magnet a, for assisting in the stabilization of the magnetic drive axle;
a magnetic magnet b, for the main response of the conversion, opposition of the magnetic repulsion;
a magnetic magnet c, for assisting in the extenuating the flux of magnet b; and
an axle support rod, for maintaining rigidness of the unit.

24. An energy efficient generator for reducing energy input for electrical generation output, comprising: a magnetic stationary magnetic axle stabilization unit, for opposing the magnetic force to the magnetic drive axle;
a cylindrical shaft axle, for supporting and centering of energy efficient generator internal components;
a magnets constructed to be like that of a turbine generators axle segment axle segment magnet, for interacting with the stationary segment of the electrical generation unit to induce electrical generation;
a magnetic, disc shaped horizontal stabilizing magnet, for ensuring the axle remains in place by preventing it from being pushed to one side or the other;
a configuration composed of twelve magnets that are cut and angled to oppose the magnets in the magnetic drive axle stationary magnetic drive, for controlling magnetic polarity of each of the magnets which are angled to cause a constant push or magnetic fall that does not cease;
a magnetic axle stabilization unit, for ensuring that the axle stays in its proper place and eliminates any wobble that would be created by the electrical generation unit;
a magnetic, rigid, generally conical magnetic drive axle, for serves to secure the twelve magnets used to oppose the magnets of the stationary magnetic drive;
a composed of a magnetic axle, composed of a stationary magnetic drive magnetic drive unit, for creating a centrifugal or gyroscopic force from responsive and directive forces contained in the magnets to cause the drive axle to rotate in the responsive direction converting the forth dimensional magnetic energy into inertial energy;
a thin, highly compressed fiber carbon, disc shaped electrical generation unit/magnetic drive unit magnetic field dampener, for retarding the intermingling of the magnetic field of the electrical generation unit with the magnetic field of the magnetic drive unit;
a thin dense disk of highly compressed carbon fiber magnetic field dampener, for retarding the transfer of magnetic energy to/from the electrical generation unit from/to the magnetic axle stabilization unit;
a copper wiring wound around magnet of the magneto copper wiring, for conducting the flow of electrons generated by the interaction of magnetic fields;
a highly compressed carbon fiber surrounding the wound copper magneto housing, for insulating the magneto from any other electro magnet or magnetic field, rigidly connected to said copper wiring;
a four magnets arranged north to north and south to south magneto, for to create an electrical charge when acted upon by another magnetic force;
a magnetic horizontal axis stabilizing magnets, for keeping the axle in place in a frictionless rotation along the given axis;
a silicon energy distribution chip, for functioning in a magnetic field while distributing the electrical energy generated by the electrical generation unit. The chip responds to the demand of electrical energy at the positive and negative nodes and the supply is produced;
a magnetic magnet aa, for working with magnet bb to create a magnetic flux pulse as in a standard electrical generator. magnet aa and magnet bb are part of the electrical generation unit;
a magnetic magnet bb, for working with magnet aa in the electrical generation unit to create a magnetic flux pulse as in a standard electrical generator;
a magnetic magnet a, for assisting in the stabilization of the magnetic drive axle;
a magnetic magnet b, for the main response of the conversion, opposition of the magnetic repulsion;
a magnetic magnet c, for assisting in the extenuating the flux of magnet b; and an axle support rod, for maintaining rigidness of the unit.
